(19) United States
(12) Patent Application Publication
(10) Pub. No.: US 2008/0181188 A1
(43) Pub. Date: Jul. 31, 2008

(54) Systems and Methods for Improving Network Mobility

(76) Inventors: Abdol Hamid Aghvami, London (GB); Paul Anthony Pangalos, London (GB); Kinan Altali Alhames, Madrid (ES)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/019,531

(22) Filed: Jan. 24, 2008

(30) Foreign Application Priority Data
Jan. 31, 2007 (GB) 0701807.0

(51) Int. Cl. H04Q 7/24

(52) U.S. Cl. 370/338

(57) ABSTRACT

A method of providing mobility between network subnets for a plurality of mobile network nodes attached to a mobile router, which mobile router hides any change in network subnet from said plurality of mobile network nodes and which network subnets provide access for said mobile router to a fixed network infrastructure, which method comprises the steps of (a) providing a signaling channel for each of said plurality of mobile network nodes; and (b) providing a data channel for each of said plurality of mobile network nodes; characterized in that said signalling channel utilises a multicast communication protocol to perform a mobility function on behalf of one or more of said plurality of mobile network nodes.

### CROSS REFERENCE TO RELATED APPLICATION(S)

This application claims foreign priority to United Kingdom Patent Application Serial No. 0701807.0, filed Jan. 31, 2007, the entire disclosure of which is herein incorporated by reference.

### BACKGROUND

1. Field of the Invention

The present invention relates to a method of providing mobility between network subnets for a plurality of mobile network nodes attached to a mobile router, a computer program and computer program product, a mobile router, a vehicle comprising such a mobile router, to a method of updating a SIP User Agent (UA) on a mobile network node, to various network nodes useable in the method, to an electronic datagram useable in a method as aforesaid, and to a data communication network for performing the method.

2. Description of the Related Art

Network mobility support is concerned with managing the mobility of an entire network, viewed as a single unit, which changes its point of attachment to a fixed network infrastructure and thus its reachability in the network topology, most frequently the Internet. The mobile part of the network is referred to as a “mobile network”, that can be installed in a train for example, and which includes one or more “mobile routers” (MRs) which act as gateways to the mobile network and connect it to the global Internet. Nodes behind the MR(s) can be classified as “Local Fixed Nodes” (LFNs) such as wired Internet access point on the train, Local Mobile Nodes (LMNs) such as mobile PDAs carried by personnel working on the train, and Visiting Mobile Nodes (VMNs) such as notebook computers and mobile telephones carried by passengers on the train. In most cases, the internal structure of the mobile network will in effect be relatively stable (no dynamic change of the topology), subject to joining and leaving of VMNs and LMNs. The MR provides wireless access for the network nodes via access routers that are part of the fixed network infrastructure. Access routers include satellites, UMTS Node Bs, GSM base stations, DVB transmitters and wireless access points.

The mobility of mobile networks does not cause the network nodes to change their own physical point of attachment, although they happen to change their topological location with respect to the global Internet. If network mobility is not explicitly supported by some mechanisms, the mobility of the MR results in mobile nodes losing Internet access and breaking ongoing sessions and connections with correspondent nodes (hereinafter CNs) in the global Internet. In addition, the communication path between the network nodes and the CNs becomes sub-optimal, and nested mobility will cause yet worse routing paths.

The current solution to provide network mobility is promoted by the NEtworks in MOtion (NEMO) working group of the Internet Engineering Task Force (see www.ietf.org/html.charters/nemo-charter.html), “Network Mobility (NEMO) Basic Support Protocol” (see RFC 3963) aims to provide connection continuity for nodes in the mobile network In particular the NEMO Basic Support Protocol provides connection (or session) continuity (e.g. continuity for TCP connections) by creating a “bi-directional tunnel” between the MR and its home network. This bi-directional tunnel is formed by encapsulating IP packets to and from the network nodes in IP packets addressed between the MR and a Home Agent on the MR's home network. In this way traffic flows are routed via the MR and its Home Agent and the mobility of the mobile network is transparent to all network nodes attached thereto. However, network nodes (particularly VMNs) can establish their own tunnels under Mobile IPv4 (MIPv4) and Mobile IPv6 (MIPv6) for example to their respective Home Agents and CNs. Thus each data packet flow between a network node in the mobile network and a CN passes through multiple tunnels before packets can be routed toward their destination. This will result in high encapsulation overhead and routing delays, particularly at the MR's Home Agent since all traffic flows must be routed therethrough.

An alternative mechanism for hiding the mobility of the mobile network from attached network nodes has been proposed that utilises the Session Initiation Protocol or “SIP”. SIP is a lightweight protocol that is described in detail in RFC 3261 to which reference is made, and the SIP-related terminology used herein is intended to be consistent with that document. At present an Internet Draft entitled “SIP-based Network Mobility (SIP-NEMO) Route Optimization” (see <draft-ming-nemo-sipnemo-01.txt>) describes how SIP can be used to overcome the multiple tunnel and routing problems described above. Three new SIP servers are defined: a SIP Network Mobility Server (SIP-NMS); a SIP Home Server (SIP-HS); and a SIP Foreign Server (SIP-FS).

When a CN wishes to establish a session with a VMN for example, the CN must send an INVITE message. This message must be sent to the VMN SIP server, on to the SIP-HS, on to the SIP-NMS and then finally to the VMN. A similar path exists if the VMN wishes to start a session with the CN. At present when establishing a session using a single SIP server in a 3G network between two SIP-enabled phones, the user can experience a typical delay of between about 5 and 6 seconds whilst the necessary SIP signalling takes place, amongst other things Accordingly it is expected that the numerous SIP servers proposed in SIP-NEMO will not reduce this delay, and may actually make it worse. Such delays are not acceptable to users.

When the SIP-NMS changes subnet it must send a RE-INVITE message to each CN that has an ongoing session with a VMN. Potentially this could by tens or hundreds of messages flooding the network. SIP-NEMO addresses the problem for the wireless link between the SIP-NMS and the fixed network infrastructure: the SIP-NMS generates a URI list of VMNs and CNs with ongoing sessions. This URI list is embedded in one INVITE message which is sent to a local SIP-FS. The SIP-FS re-produces an INVITE message for each CN in the list. Therefore the network flooding problem is not really addressed by SIP-NEMO, but rather shifted to another part of the network.

Accordingly it is an aim of at least some embodiments of the invention to improve the signalling efficiency for mobile network nodes attached to a mobile router, and in particular but not exclusively to reduce the time required for the SIP signalling to establish a session between such a mobile network node and a correspondent node. Another aim of the invention is to reduce the signalling overhead when a mobile router changes its point of attachment to the fixed network infrastructure.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

According to the present invention there is provided a method of providing mobility between network subnets for a plurality of mobile network nodes attached to a mobile router, which mobile router hides any change in network subnet from said plurality of mobile network nodes and which network subnets provide access for said mobile router to a fixed network infrastructure, which method comprises the steps of: (a) providing a signaling channel for each of said plurality of mobile network nodes; and (b) providing a data channel for each of said plurality of mobile network nodes; characterized in that said signalling channel utilises a multicast communication protocol to perform a mobility function on behalf of one or more of said plurality of mobile network nodes. In one embodiment the multicast communication protocol is IP multicast. The mobile network nodes may be any type of node that has mobility capabilities at the network layer; such capability may be provided by using a wireless or wired interface. Such devices include, but are not limited to, mobile telephones, PDAs, laptops, notebooks, hand-held gaming devices, and audio/video storage and playback devices. Use of the multicast communication protocol may be co-ordinated by one or more network node and/or one or more logical entity. In one embodiment the mobile router may be involved in the co-ordination. In another embodiment a SIP server in the mobile router's home network may be involved in the co-ordination.

The mobility function may comprise a registration function in which the multicast communication protocol is used to register the current location of the mobile router with a respective remote entity (e.g. a SIP server) associated with each mobile network node. In this way the reachability of the mobile network nodes at the network layer can be maintained as the mobile router changes its point of attachment to the network. Additionally or alternatively the mobility function may comprise a session continuity (or handover) function in which the multicast communication protocol is used to preserve ongoing sessions upon a change in reachability at the network layer of the mobile router.

Preferably, the method further comprises the step of establishing sessions for said plurality of mobile network nodes using said multicast communication protocol whereby routes to and from said mobile router for both said signalling channel and said data channel are substantially route optimised. In other words the route taken by datagrams on each channel is improved and in particular mitigates the need for signalling data to be sent via more servers (e.g. SIP servers) than is necessary.

Advantageously, the method further comprises the step of utilising a plurality of multicast groups on behalf of said plurality of mobile network nodes.

Preferably, use of the or each multicast group enables a respective function to be performed for said plurality of mobile network nodes whilst attached to said mobile router. For example in addition to the mobility function, the multicast communication protocol may be used to perform other management functions on behalf of the mobile network nodes, such as billing and/or AAA.

Advantageously, each mobile network node is associated with a remote network node that provides a session management function therefor, the method further comprising the step of causing all of the remote network nodes to join a first multicast group, whereby changes in a network layer address of said mobile router may be notified to all of said remote network nodes with a single multicast message. If a SIP type protocol is used for signalling the remote network nodes may each comprises a SIP server. The remote network node may comprise a logical entity, such as a SIP server, to handle the session management function. Usually the remote network node will be in the home network of the mobile network node, although this is not essential. The home network is that network subnet where the mobile network node has a permanent IP address.

Preferably, the step of causing said remote network nodes to join said first multicast group comprises: (a) receiving from a mobile network node a registration message intended to update said associated remote network node; and (b) adding to said registration message a multicast address field comprising the first multicast address of said first multicast group; and (c) forwarding said registration message toward said associated remote network node; whereby said remote network node is caused to join said first multicast group. In one embodiment it is possible for the mobile router to perform all of steps (a) to (c). Step (c) may comprise forwarding the registration message over any path (as decided by routers in the network), or it may comprise forcing the registration message to pass via a specific network node, such as a SIP server (MR-SS) representing the mobile router.

Advantageously, when said mobile router changes network subnet the method further comprises the steps of: (a) generating a group register message comprising the new care-of network layer address of said mobile router and a list of those mobile network nodes presently attached thereto; and (b) causing said group register message to be sent to said first multicast group using said first multicast address. Steps (a) and (b) are preferably performed by the mobile router. However, it is possible for the mobile router to perform step (a) and then forward the group register message to another network node (e.g. the SIP server of the mobile router) that performs step (b).

Preferably, the method further comprises the step of forming a second multicast group comprising one or more remote network node associated with the or each mobile network node for which a session has been established. In the present context a session means a lasting connection (in the logical sense) between a mobile network node attached to the mobile router and a between a remote network node. As such the connection may be reliable (e.g. TCP) or unreliable (e.g. UDP). A session may be implemented as a layer in a network protocol (e.g. telnet or FTP). In the case of transport protocols which do not implement a formal session layer (e.g. UDP) or where sessions at the session layer are generally very short-lived (e.g. HTTP), sessions are maintained by a higher level program using a method defined in the data being exchanged. For example, an HTTP exchange between a browser and a remote host may include an HTTP cookie which identifies state, such as a unique session ID, information about the user's preferences or authorisation level.

Advantageously, forming said second multicast group comprises the step of causing said one or more remote network node to be invited to join said second multicast group during establishment of said session, whereby the number of members of said second multicast group is dynamic.

Preferably, said one or more remote network node comprises a correspondent node with which said mobile network node has an ongoing session.

Advantageously, said one or more remote network node provides a session management function for said mobile network node with an ongoing session. The remote network node may be a SIP server for example.

Preferably, the method further comprises the steps of: (a) detecting a change in the network layer address of said mobile router; and (b) causing the new network layer address of said mobile router to be sent to the multicast address of said second multicast group, whereby only those remote network nodes associated with the or each mobile network node with an ongoing session are updated with said new network layer address. In one embodiment the mobile router performs step (a), whereas a network node remote from the mobile router (e.g. the SIP server of the mobile router) performs step (b).

Advantageously, the method further comprises the step of sending a group invitation message to said second multicast group, which group invitation message comprises an identity of each correspondent node that has an ongoing session with at least one of said mobile network nodes.

Preferably, upon receipt of said group invitation message, said correspondent node searches said group invitation message for its identity and, if found, addresses datagrams in said data channel to said new network layer address. In this way sessions can be preserved during handover of the mobile router from one subnet to another.

Advantageously, provision of said signalling channel comprises the step of sending messages in accordance to the Session Initiation Protocol (SIP).

Preferably, said multicast function is provided by a SIP server (MR-SS) remote from said mobile router, said multicast function being triggered by messages sent from said mobile router.

According to another aspect of the present invention there is provided a computer program comprising computer executable instructions for causing a mobile router to perform any of the mobile router method steps set out above.

The computer program may be supplied in the form of a computer program product storing the instructions.

The computer program product may be embodied on a record medium, in a computer memory, in a read-only memory or on an electrical carrier signal.

According to another aspect of the present invention there is provided for use in a method according as set out above, a mobile router comprising an electronic memory storing computer executable instructions that when executed enable the mobile router to perform any of the mobile router steps set out above.

According to another aspect of the present invention there is provided a mobile network comprising a mobile router as set out above.

The mobile router may be part of a vehicle.

According to another aspect of the present invention there is provided a method of updating a SIP User Agent (UA) on a mobile network node, which method comprises the steps of transmitting an update to said mobile network node and causing said mobile network node to install said update; which update comprises computer executable instructions for causing said mobile network node to join a multicast group in response to receipt of a SIP-like signalling message.

According to yet another aspect of the present invention there is provided a mobile network node comprising a memory storing computer executable instructions for causing said mobile network node to join a multicast group in response to receipt of a SIP-like signalling message.

According to another aspect of the present invention there is provided a network node (MR-SS) for managing a plurality of mobile network nodes attached to a mobile router, which network node comprises a memory storing computer executable instructions that when executed cause said network node to provide a signalling channel for said mobile network nodes by utilising a multicast communication protocol.

Such a network node may comprise a SIP server.

According to another aspect of the present invention there is provided for use in a method as aforesaid, a datagram comprising a signalling message in its payload, which signalling message comprises a SIP-like message structure having a header field comprising a multicast address, said datagram useable to cause remote network nodes to join a multicast group represented by said multicast address.

According to another aspect of the present invention there is provided a data communication network adapted to perform any of the method steps set out above.

### BRIEF DESCRIPTION OF THE DRAWINGS

For a better understanding of how the invention may be put into practice, a preferred embodiment of the invention implemented on a train will be described, by way of example only, with reference to the accompanying drawings, in which:—

FIG. 1 is a schematic block diagram of a network environment with a mobile network attached thereto;

FIG. 2 shows the network of FIG. 1 during a first stage of signalling according to the present invention;

FIG. 3 shows the network of FIG. 1 during a second stage of signalling according to the present invention;

FIG. 4 shows the network of FIG. 1 during a third stage of signalling according to the present invention;

FIG. 5 shows the network of FIG. 1 during a fourth stage of signalling according to the present invention;

FIG. 6 is a block diagram of a mobile router according to the present invention;

FIG. 7 is a block diagram of a network node according to the present invention; and

FIG. 8 is a block diagram of a mobile network node according to the present invention.

### DESCRIPTION OF THE PREFERRED EMBODIMENT(S)

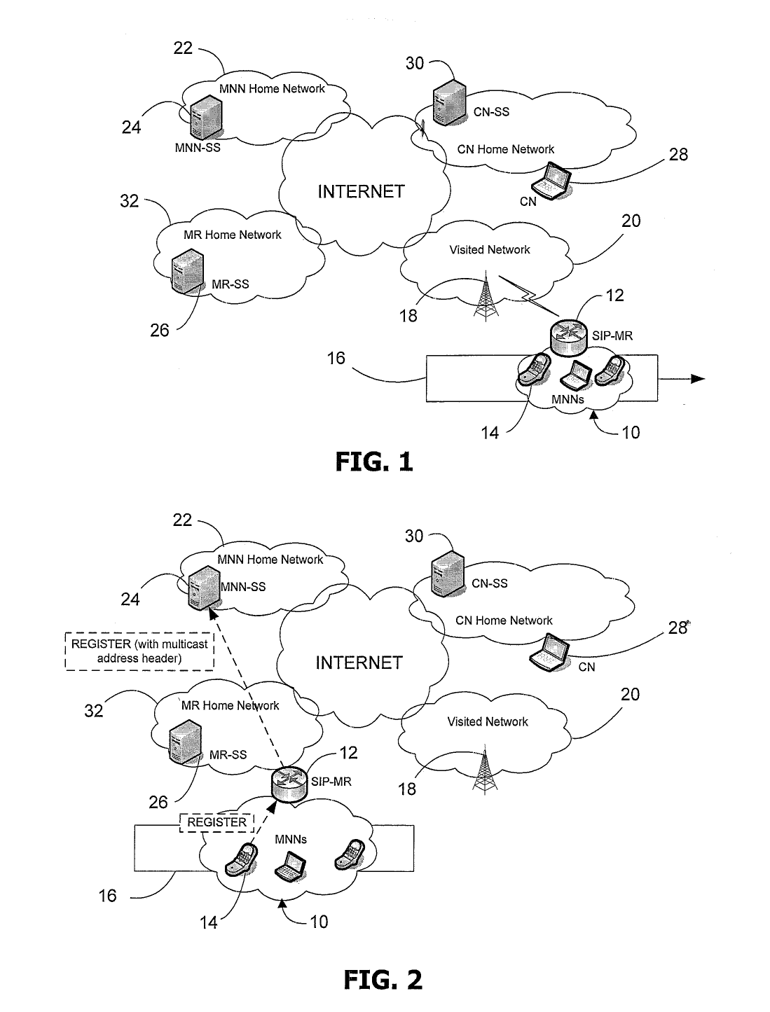

Referring to FIG. 1 a mobile network generally identified by reference numeral 10 comprises a SIP-enabled mobile router (SIP-MR) 12, serving a SIP-enabled Visiting Mobile Node (VMN) 14 (that may or may not have multi-mode capability) via an Access Point (AP; not shown). The SIP-MR 12 performs the functions of User Agent on behalf of the MNNs attached to the mobile network 10. In particular the SIP-MR 12 comprises a User Agent Client (UAC) which generates requests, and a User Agent Server (UAS) which responds to them. The AP may be a wireless access point or a wired access point. The mobile network 10 is part of a train 16 that moves relative to a number of physically fixed access routers (only one shown, 18) that are not part of the train 16: access router 18 operates under a wireless local area network (WLAN) communication protocol such as IEEE802.11; other access routers might utilise a DVB transmission protocol, a Universal Mobile Telecommunication System (UMTS) communication protocol, or other IMT-2000 communication protocol. Each of the access routers provides wireless access for the SIP-MR 12 and the VMN 14 to a fixed packet-switched network, such as the Internet, so that the VMN 14 can send and receive packet data from the train, both whilst moving and stationary. The current network to which the SIP-MR 12 is attached is sometimes known as the ‘Visited Network’ 20.

The SIP-MR 12 has an ingress interface for receiving IP packets from and transmitting IP packets to network nodes in the mobile network 10, and an egress interface for receiving IP packets from and transmitting IP packets to the fixed packet-switched network. As explained above, one of the aims of the NEMO Basic Support is to ensure that the motion of the train 18 is transparent to any network nodes (LFN, LMN and/or VMN) behind the SIP-MR 12. Motion of the train past the access routers necessitates network layer handover of service from one access router to another. Since the SIP-MR 12 connects an entire network to remote packet networks, each change in point of attachment (i.e. change in access router) to the remote packet networks causes the reachability of the entire mobile network 10 to change.

The Mobile Internet Protocol (Mobile IP) was designed specifically to handle the routing of IP data packets to and/or from mobile nodes i.e. mobile terminals that frequently change their point of attachment to the Internet. Moreover, Mobile IP was designed to handle the routing of IP data packets to and/or from mobile nodes without significantly interrupting on-going communications and without requiring mobile nodes to restart applications. Presently there are two versions of Mobile IP that have been proposed by the Internet Engineering Taskforce (IETF): Mobile IPv4 and Mobile IPv6. One of the common features between the two protocols is that an interface on each mobile node has (1) a “home address” i.e. a permanent IP address for an interface associated with the mobile node's point of attachment to the Internet at its home network, and (2) a “care-of address” i.e. a temporary IP address that is assigned to the interface when the mobile node attaches to a foreign network.

If the SIP-MR 12 is at its home network the prefix advertised over the ingress interface matches the prefix of the egress interface of the SIP-MR 12. Accordingly, when a VMN 14 moves into the area served by the SIP-MR 12 and AP 16 the newly configured care-of address is topologically correct i.e. IP packets addressed to the care-of address configured using the prefix of the ingress interface will be routed correctly and reach the egress interface of the SIP-MR 12 where they are routed to the VMN 14. However, when the mobile network 10 moves away from its home network (for example the station where the train 18 commences its journey), the care-of address configured by the VMNs from the ingress interface of the SIP-MR 12 is no longer topologically correct and IP packets sent by CNs will not reach their destination.

There are two main aspects to enable communication between the VMN 14 and correspondent node: (1) provision of a signalling channel for each MNN 14 (including correct routing of the signalling messages used in establishing a session); and (2) provision of a data channel for carrying datagrams of the session once a connection has been established (including correct routing of the datagrams).

In FIG. 1 the VMN 14 has a mobile network node SIP server (MNN-SS) 24 in its home network 22. The SIP-MR 12 has a mobile router SIP server (MR-SS) 26 with which it is associated. A correspondent node (CN) 28 has a correspondent node SIP server (CN-SS) 30. Each of the SIP servers has the functionality of a SIP proxy server as defined in RFC 3261, as well as the functionality described herein. Therefore each of the SIP servers acts to route SIP messages toward its associated node. It should be noted that SIP server's are logical rather than physical entities and are shown in FIG. 1 as separate physical entities in each of the respective networks purely as an aid to understanding and for clarity. The SIP servers could be located anywhere in the network and some or all of them may even reside on the same physical hardware.

The SIP-MR 12 plays a role in provision of the signalling channel and to that end manages the following processes: (a) MNN registration: recording each MNN joining and leaving the mobile network 10; and (b) CN registration: recording each CN with which each MNN has an ongoing session.

By utilizing a first multicast address for MNN registration and a second multicast address for CN registration, it is possible to provide a signalling channel for the MNNs that is more efficient in operation and, in particular, is expected to reduce delays inter alia for session establishment prior to data flow in the data channel. It is envisaged that any number of multicast addresses may be utilised to form one or more signalling channel. Other functions that may utilise a multicast address may include billing, Authentication, Authorisation and Accounting (AAA).

The operation of the SIP-MR 12 can be broken down conveniently into four stages: registration, pre-call mobility, call set-up and mid-call; although it is to be noted that any combination of these stages can happen at the same time. Referring to FIG. 2 the mobile network 10 is shown attached to its home network 32. Mobile nodes may join and leave the mobile network 10; for example as passenger's join and leave the train 16 whilst it is standing in a station.

### Stage 1: Registration

As explained above when the MNN 14 joins the mobile network 10 it will configure a new care-of address based on the network prefix advertised by the SIP-MR 12. When the MNN 14 has configured a new IP address it should register this new address with the MNN-SS 24 by sending a REGISTER message as prescribed in RFC 3261. The MR-SS 12 is configured to intercept REGISTER messages from attached network nodes. When such a message is received, the SIP-MR 12 performs the following operations:

(1) change the REGISTER line of the message to contain its own current care-of address (i.e. of the egress interface) rather than that of the MNN 14.

(2) add a new header to the message containing a multicast address of a multicast group that the MNN-SS 24 must join. The multicast group is called the Multicast Registration Group (MRG).

(3) store in memory the SIP URI of the MNN 14 together with the Call-ID specified in the Call-ID header field.

(4) forward the amended REGISTER message toward the MNN-SS 24 (see FIG. 2).

When the MNN-SS 24 receives the REGISTER message it is processed and the binding for the MNN 14 is updated to point toward the care-of address of the SIP-MR 12. The MNN-SS 24 also joins the multicast group MRG by utilising the Internet Group Management Protocol (IGMP). In this way all of the MNN-SSs associated with all of the MNNs attached to the mobile network 10 become members of the MRG.

The MNN-SS 24 then sends a 200 OK response addressed to the care-of address of the SIP-MR 12. This message contains a copy of the REGISTER message. When the SIP-MR 12 receives the 200 OK message it replaces the IP address in the From header field (of the copy of the REGISTER message), from that of the SIP-MR 12 to that of the MNN 14. Of course, there will be many 200 OK messages received by the SIP-MR 12. In order to distinguish which message is intended for which MNN the SIP-MR 12 may use the Call-ID field to look up the corresponding SIP URI. The amended 200 OK message is then forwarded on to the MNN 14. Accordingly interception of REGISTER and 200 OK messages by the SIP-MR 12 is transparent to the MNNs in the mobile network 10.

It is not essential that the SIP-MR 12 comprise the registration functionality embodied by steps (1)-(4) above. For example it is possible that all of the steps are performed by the MR-SS 26, or another entity in the fixed part of the packet-switched network.

### Stage 2: Pre-Call Mobility

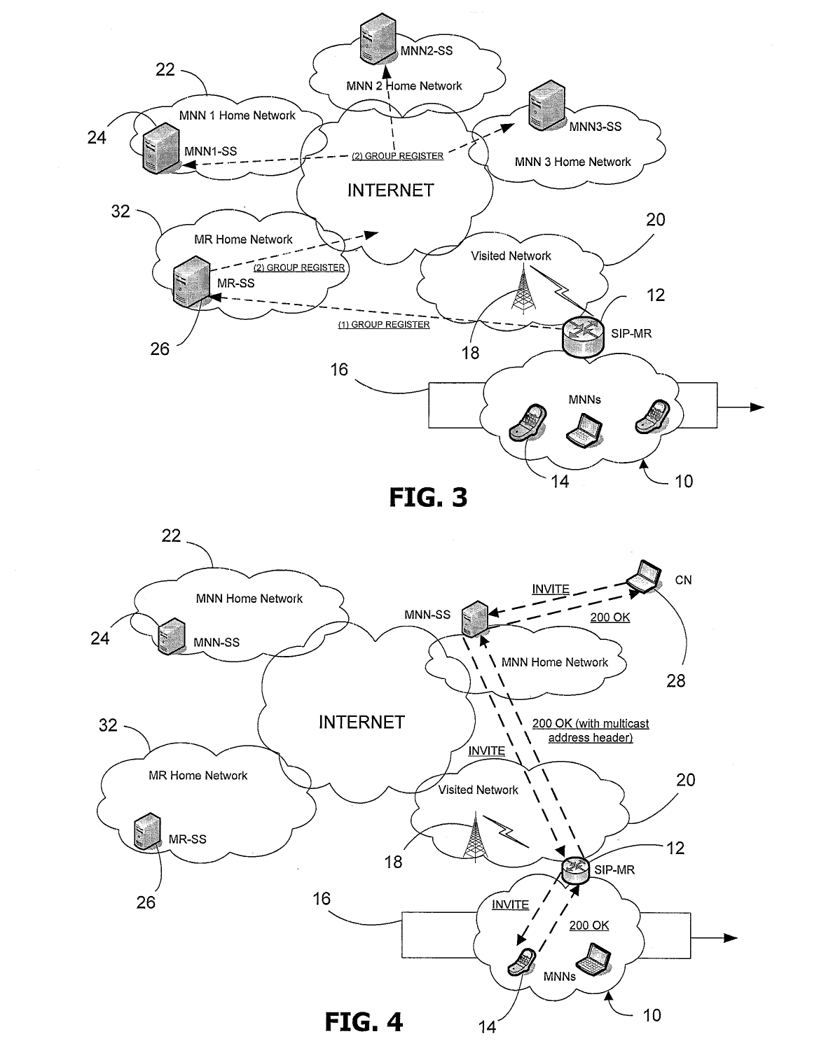

Referring to FIG. 3 the mobile network 10 is in motion and has moved to the visited network 20. Accordingly the SIP-MR 12 configures a new care-of address for its egress interface using the network prefix advertised by the access router 18 in the visited network. Once configured, the SIP-MR 12 needs to update the MR-SS 26 and all of the MNN-SSs with the new care-of address. FIG. 3 illustrates the signalling that takes place during this stage.

The MR-SS 12 composes a GROUP REGISTER message; this message is a SIP-like message similar in structure to a REGISTER message. However, the GROUP REGISTER message comprises a list of URIs of the MNNs attached to the mobile network 10 and the new care-of address of the SIP-MR 12. The GROUP REGISTER message is unicast to the MR-SS 26. It is assumed that, prior to composing the GROUP REGISTER message, the SIP-MR 12 has sent a REGISTER request to the MR-SS 26 so that the MR-SS can update its Binding List (see the SIP-NEMO draft for further details).

When the MR-SS 26 receives the GROUP REGISTER message it sends a 200 OK message back to the SIP-MR 12 (which contains a copy of the GROUP REGISTER message). After that the MR-SS 26 encapsulates the GROUP REGISTER message in an IP datagram, inserts the MRG multicast address in the Destination IP address field and sends the datagram into the network. The forwarded GROUP REGISTER message is received by each MNN-SS 24 that is a member of the multicast group. On receipt of the GROUP REGISTER message each MNN-SS 24 searches the URI list contained in the message for any URI belonging to its domain. If one or more is found, the binding for the or each MNN is updated to point toward the new care-of address of the SIP-MR 12. In this way all MNN-SSs of the Multicast Registration Group are updated substantially at the same time by sending only one message from the MR-SS 26.

If desired the GROUP REGISTER message could be multicast directly from the SIP-MR 12, or from the same entity that handles the registration function.

### Stage 3: Call Setup

When the CN 28 wishes to establish a session with the MNN 14, it sends and INVITE message to the MNN-SS 24 via intermediate SIP proxies (e.g. CN-SS 30). Since the MNN-SS 24 is always updated with the current care-of address of the SIP-MR 12, it is able to forward the INVITE message directly toward the SIP-MR 12, instead of having to forward it toward the MR-SS 26. This is a considerable advantage since two legs of the route (MNN-SS→MR-SS, and MR-SS→SIP-MR) are avoided. It is expected that this will reduce the delay that would be caused by using the signalling described in SIP-NEMO.

It will be recalled that, in order to hide the network layer mobility of the MR-SS 12, the IP address configured and used by each MNN is static while it is attached to the mobile network 10. Therefore when composing SIP messages, MNNs will not use a correct globally routable IP addresses in the To and From header fields for example; rather they will use an IP address configured from the home network of the SIP-MR 12. If these addresses were relied upon by the CN 28 after the SIP call setup procedure had concluded, datagrams of the media session would not be routed correctly. This problem has been addressed in a document entitled “Getting SIP through Firewalls and NATs” by Rosenburg, J. et al., 22 Feb. 2000, available as Internet Draft <draft-rosenburg-sip-firewalls-00.txt>. Two solutions are proposed in that document: use an application layer firewall/NAT which understands SIP, or use a packet filtering firewall/NAT under the control of a proxy. It is intended that the SIP-MR 12 should adopt either of these solutions in order to enable call setup between the MNN 14 and the CN 28 and vice versa. Accordingly reference is specifically made to the whole of the Rosenburg document for that purpose.

Another document describing how SIP messages may traverse firewalls and NATs is presently found at http://www.sipcenter.com/sip.nsf/html/SIP+Firewall+and+NAT+Traveral. This document describes how Applicant Layer Gateway functionality may be built into a ‘smart’ SIP phone (or any other communication device) so that the phone can learn whether or not it is behind a NAT (i.e. in the present case the SIP-MR 12) and the public IP address it has been assigned by the NAT. In this way the SIP phone may use the correct public IP address in any SIP messages it sends, thereby ensuring that datagrams are properly routed once the connection has been established. A solution as described in this document may also be used to enable session establishment as described herein.

Referring to FIG. 4 when the SIP-MR 12 receives the INVITE message it checks the URI in the To header field against the binding list of MNNs attached to the mobile network 10. If located, the INVITE message is amended changing the IP address in the To header field to the IP address of the MNN 14 so that it may be processed by the MNN in the normal way. If the MNN 14 accepts the invitation it will compose and send a 200 OK response addressed to the CN 28. This message is intercepted by the SIP-MR 12 which adds a header containing a Multicast Invitation Group (MIG) multicast address. CNs receiving the modified 200 OK message must join the MIG and may use IGMP to do so. The SIP-MR 12 then stores in memory the SIP URI of the MNN 14 together with the Call-ID that has been assigned by the CN 28 in the original INVITE message.

In a similar way, if the MNN 14 sends an INVITE message to the CN-SS (see FIG. 1) in order to request a connection, the SIP-MR 12 intercepts the INVITE message and adds a header containing the MIG multicast address that the CN 28 must join.

Accordingly the SIP-MR 12 intercepts both outgoing and incoming SIP signalling messages and adjusts them as described above, whereby it is ensured that the CN 28 joins the MIG.

Once the session is established by the SIP signalling, datagrams (e.g. audio, video) in the data channel (i.e. IP unicast) must only pass via the SIP-MR 12. It is not necessary for the data to pass via any other of the SIP entities and therefore the route optimising advantage described in SIP-NEMO is preserved. Furthermore, the session establishment via the signalling channel is more efficient.

At the end of all sessions with the MNN 14, the CN 28 is configured to leave the MIG.

### Stage 4: Mid-Call

If the train 16 is in motion it will be necessary at some point for the SIP-MR 12 to handover from one access router to another. Some of these handovers may result in the SIP-MR 12 changing its topological position in the Internet i.e. the subnet to which it is attached will change and therefore it will require a new care-of address. All of this may happen whilst there are ongoing connections and/or sessions between MNNs attached to the SIP-MR 12 and CNs elsewhere. Once the egress interface of the SIP-MR 12 obtains a new care-of address, the public IP addresses previously used by the MNNs to establish the current sessions will not be valid, and data in the data channel will be incorrectly routed.

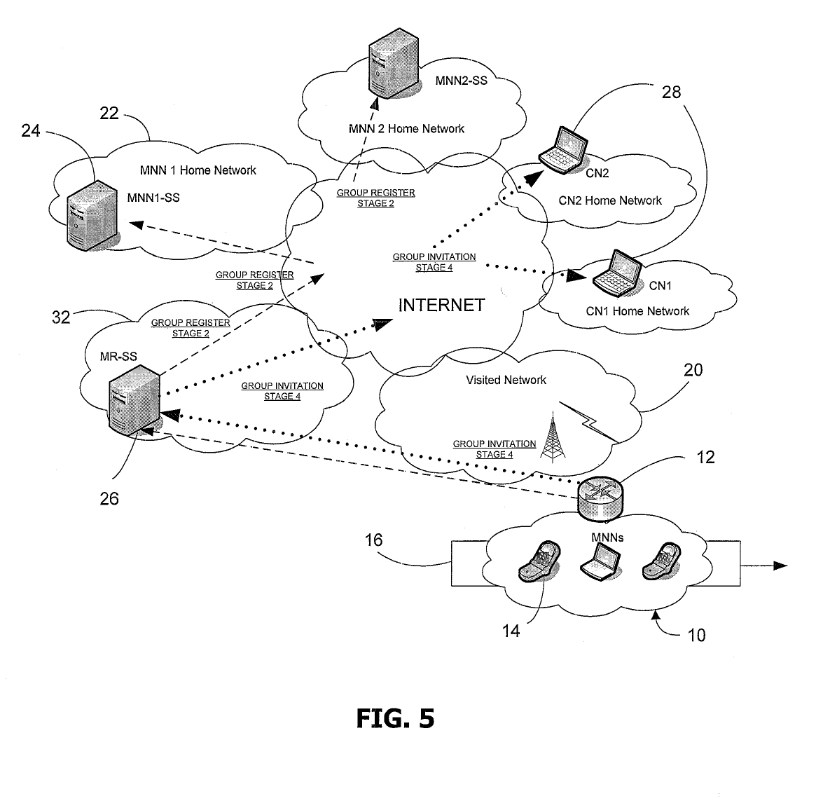

This network-layer mobility must be hidden from the MNNs attached to the SIP-MR 12. Referring to FIG. 5 the SIP-MR 12 performs the pre-call mobility procedures described above under Stage 2. In that way, all of the MNN-SSs are updated with the new care-of address of the SIP-MR 12.

Then the SIP-MR 12 re-invites all of the CNs that are in ongoing sessions with MNNs. To that end it composes a GROUP_INVITATION message which comprises the new care-of address of the SIP-MR 12 and a list containing the SIP URI of each CN with an ongoing session, together with a the associated Call-ID. The GROUP_INVITATION message may be based on the re-INVITE message described in RFC 3261. The GROUP_INVITATION message is then unicast to the MR-SS 26. One advantage of this is that it is not necessary for the visited network 20 to have multicast capability for the invention to work. Alternatively it is possible for the SIP-MR 12 to address the GROUP_INVITATION to the MIG, rather than involving the MR-SS 26, although this would require to SIP-MR 12 to join and leave the MIG multicast group at each handover.

On receipt of the GROUP_INVITATION message the MR-SS 26 stores the list of URIs and forwards the message to the MIG i.e. all of the CNs that have joined the Multicast Invitation Group. The MR-SS 26 may remove the IP header from the GROUP_INVITATION message and replace it with a new multicast IP header in which its IP address is contained in the Source Address field. Alternatively the MR-SS 26 may simply encapsulate the entire message as received from the SIP-MR 12 with a multicast IP address header.

Upon receiving the GROUP_INVITATION message, each CN 28 searches the URI list for its own SIP URI and, if found, for security purposes checks if the corresponding Call-ID listed in the message matches that stored by it during the call setup. Assuming that these two checks are passed, the CN 28 can now use the new care-of address of the SIP-MR 12 in the Destination field of IP datagrams it sends to the MNN 14. Each CN should send a 200 K to the server that sent the GROUP_INVITATION message (in this case the MR-SS 26). The IP address of the MR-SS 26 can be obtained by each CN from the Source Address field of the multicast IP packet containing the GROUP_INVITATION message. Either once the MR-SS 26 receives a 200 OK message from all of the CNs (utilising the list previously stored in memory for comparison purposes), or after a certain period of time, it will in turn send a 200 OK to the SIP-MR 12. This 200 OK contains a list of the URIs of those CNs that have sent a 200 OK. By sending one 200 OK from the MR-SS 26 to the SIP-MR 12 a signalling storm on the radio interface is avoided that would otherwise occur if each CN sent a 200 OK to the SIP-MR 12. If some CNs have not responded (for whatever reason) then their URI address will not be included in the final 200 OK message sent to the SIP-MR 12.

By virtue of their membership of the MIG, all of the CNs with ongoing sessions are updated with the new care-of address of the SIP-MR 12. It is expected that this update will happen much more quickly than the procedures descried in SIP-NEMO. Therefore delays and lost connections due to handover of the SIP-MR 12 should be reduced.

It is envisaged that other entities may join the MIG instead. For example the CN-SS 30 may join the MIG whenever it receives an INVITE message (either from the CN 28 destined for the MNN 14 or from the MNN 14 destined for the CN 28). Alternatively the CN-SS 30 may join the MIG whenever it receives a 200 ACK message (either from the CN 28 destined for the MNN 14 or from the MNN 14 destined for the CN 28). The latter option may be preferable in most circumstances since the ACK message confirms acceptance of the INVITE message and therefore that a session will be established. Assuming that the CN-SS 30 joins the MIG, when it receives the GROUP_INVITATION message it will search its Binding List for the SIP URI of the CN 28 and, if found, will compose a re-INVITE message and send it directly to the CN 28. When the CN-SS 30 receives a 200 ACK from the CN 28 it will re-direct that message to the MR-SS 26. The MR-SS 26 collects these messages and sends one 200 OK to the SIP-MR 12 as described above. One particular advantage of the CN-SS 30 (or other similar entity) joining the MIG is that, since User Agent Clients can process re-INVITE messages as described in RFC 3261, the mobility of the SIP-MR 12 is completely hidden from both the CN 28 and MNN 14.

Another alternative is that the MNN-SS 24 may join the MIG during the call setup stage. Therefore when it receives a GROUP_REGISTER message from the SIP-MR 12 it may compose a re-INVITE message and send it directly or indirectly (e.g. via the CN-SS 30) to the CN 28. However, to reduce signalling delays it is preferable if the CN 28 joins the MIG.

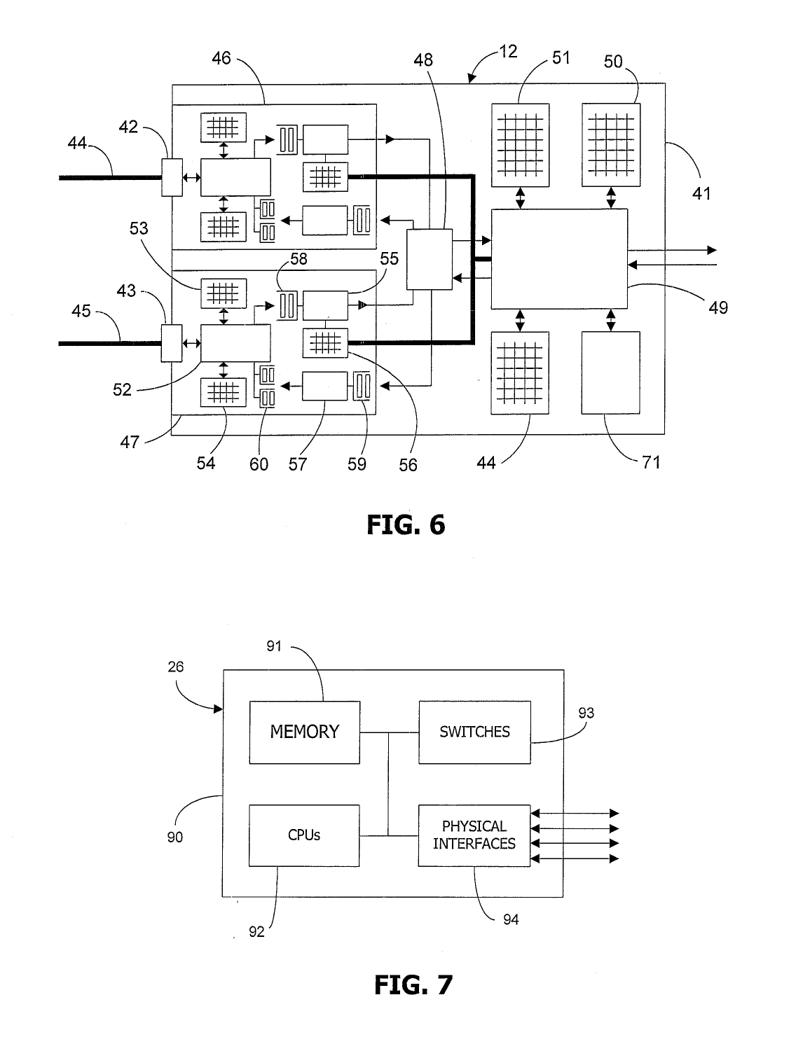

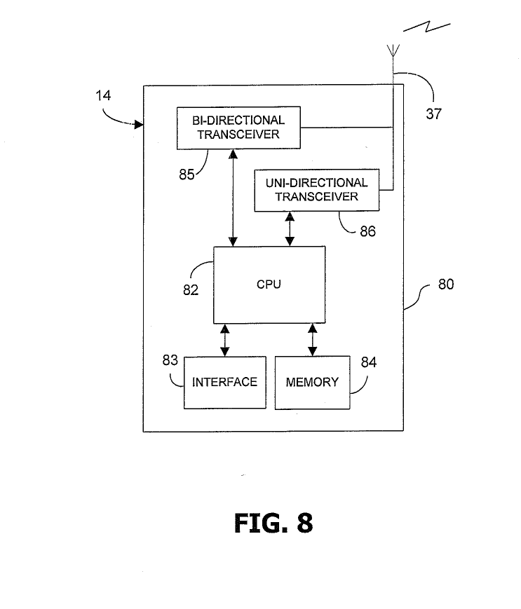

FIG. 6 shows the SIP-MR 12 that comprises a case 41 having network interface ports 42 and 43 to which respective cables 44 and 45 provide a physical link to respective IP networks. Two network interface cards 46 and 47 are connected to their respective network interface ports 42 and 43 and form the ingress interface and egress interface respectively. A hardware packet switch 48 connects the network interface cards 46, 47 and a central processing unit (CPU) 49 can communicate with a routing table 50 and router management tables 51.

Each network interface card 46, 47 comprises a link layer protocol controller 52 that has access to an interface management table 53 and a hardware address table 54 (e.g. Address Resolution Protocol cache). In communication with the link protocol controller 52 is a network protocol-forwarding engine 55 having access to a forwarding table 56 (route cache), and an interface queue manager 57. Both the network protocol forwarding engine 55 and interface queue manager 57 have an interface to and from the packet switch 48 respectively.

In use, frames are received by the link layer protocol controller 52 that handles the link layer protocol (e.g. HDLC, Ethernet) used over the physical link. Frame integrity is checked and valid frames are converted into packets by removing the link layer header and, if necessary, the packets are queued in a queue 58. Storage capacity is often in the form of a ring of memory buffers. One packet at a time is removed from the queue 58 by the network protocol-forwarding engine 55 and the forwarding table 56 determines whether or not the packet requires detailed examination by the CPU 49. Via the CPU 49 the next router to which the packet should be sent is looked up in the routing table 50. If the IP packet arrived on the ingress interface (i.e. from within the mobile network 10) the CPU 49 examines the packet to determine whether or not it contains a SIP message in the payload, and if so, whether or not it requires amendment as described above. Similarly if the packet has been received on the egress interface (i.e. from the access router over the wireless link) the CPU 49 performs the same function.

Once the destination IP address is determined the CPU 49 searches the ARP cache for a Media Access Control (MAC) address for that destination. The CPU 49 now knows where to send the packet and the new link layer header to use. The link layer address is added and the packet is linked into the list of frames to be sent on from the appropriate network interface card. The packet is then forwarded to the packet switch 48 and onto the network interface card where the packet joins a queue 59 to be processed by the interface queue manager 57. From here the packet joins one of a number of link output queues 60 until the link layer protocol controller 52 can process it. The link layer protocol controller 52 encapsulates the packet in a link layer header that includes the Media Access Control (MAC) address of the next router to which the packet is to be sent. The MAC address is obtained from the hardware address table 54. The packet is then placed on the physical channel by the link layer protocol controller 52.

An electronic memory 71 stores computer executable instructions that when executed by the CPU 49 bring about a SIP server in the SIP-MR 12 with the functionality described herein.

Various types of mobile router are available and the present invention is not limited to that described above. Further examples are available from Cisco Systems, Inc. (www.cisco.com) for example.

Referring to FIG. 7 a block diagram of the MR-SS 26 shows some of the physical components of a network node required to bring about the functionality of the MR-SS 26 as described herein. A case 70 houses and electronic memory (e.g. hard disk, RAM, etc.), one or more CPU 72, one or more switch 73, and one or more physical interface 74. All of these components are in electronic communication with one another. Each physical interface 74 is connected to an external packet data network for the purposes of routing packets at the network layer. At the application layer the network node may operate various logical entities such as, but not limited to, those providing a billing function and a mobility management function for example. The network node also stores computer executable instructions in the memory 71 that bring about the functionality of the MR-SS 26 as described herein. Accordingly the network node has multicast capability.

A generally similar block diagram may described the components of the other SIP servers (e.g. MNN-SS 24, CN-SS 30) described herein.

Referring to Fig. the MNN 14 comprises a case 80 housing a CPU 82, an interface 83, a memory 34, a bi-directional transceiver BT 85, and a uni-directional transceiver UT 8. The BT 85 and UT 86 are wired to an antenna 87 for wireless reception and transmission of data to and from the fixed network infrastructure (e.g. Internet, possibly via one or more intermediate networks). The two transceivers enable the MNN 14 to be multi-mode i.e. capable of transceiving data under difference communication protocols (e.g. UMTS, DVB, DAB), although it is to be noted that it is not essential for the MNN 14 to have this functionality. The CPU 82 interfaces with all of the aforesaid components to process (store, access, etc.) electronic data. The memory 84 stores computer executable instructions that when executed by the CPU 82 perform the MNN steps described above. In particular, the MNN 14 operates a SIP User Agent having the functionality described herein. The functionality could be loaded onto the MNN 14 at point of manufacture or could be made available to the MNN 14 in the form of an update downloadable from the fixed network infrastructure. However, in some embodiments it is not necessary to for the MNN 14 to have the extended functionality of the invention since other network nodes may perform this functionality on behalf of the MNN 14.

A generally similar block diagram may describe the components of the correspondent node 28. In this connection it will be noted that the terms ‘mobile network node’ and ‘correspondent node’ are simply terms of convenience to provide clarity when describing signalling and data transactions. In reality mobile network nodes and correspondent nodes may be identical (in hardware terms) or they may be different.

The multicast signaling technique as described herein can be used to perform various functions on behalf of mobile network nodes e.g. group handovers, load-balancing (where MNNs are subscribed to a group and then handed over from one access router to another as a single group).

Examples of mobile networks include, but are not limited to:

(a) networks attached to people (“Personal Area Networks” or PANs): a mobile phone with one cellular interface and one Bluetooth interface together with a Bluetooth-enabled PDA. The mobile phone is the MR while the PDA is used for web browsing or runs a personal web server;

(b) networks of sensors and computers deployed in vehicles: vehicles are provided with an increasing number of processing units for safety and ease of driving, as well as Internet access for passengers;

(c) access networks deployed in public transportation (buses, trains, taxis, aircraft, etc.): they provide Internet access to IP devices carried by passengers (e.g. laptop, camera, mobile phone representing host mobility within network mobility, or PANs i.e. network mobility within network mobility or “nested mobility”); and

(d) ad-hoc networks connected to the Internet via a MR: for example students in a train that need to set up an ad-hoc network amongst themselves and then enable the ad-hoc network with Internet access through the MR.

Mobile routers may be installed in a wide range of vehicles including private vehicles (e.g. cars, motorbikes), public transport and military vehicles (aircraft, tanks, lorries, boats, etc.)

Although the embodiment of the invention described with reference to the drawings comprises computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program. For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant methods.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art

1. A method of providing mobility between network subnets for a plurality of mobile network nodes attached to a mobile router, which mobile router hides any change in network subnet from said plurality of mobile network nodes and which network subnets provide access for said mobile router to a fixed network infrastructure, which method comprises the steps of:
(a) providing a signaling channel for each of said plurality of mobile network nodes; and
(b) providing a data channel for each of said plurality of mobile network nodes;
characterized in that said signalling channel utilises a multicast communication protocol to perform a mobility function on behalf of one or more of said plurality of mobile network nodes.

2. A method according to claim 1, further comprising the step of establishing sessions for said plurality of mobile network nodes using said multicast communication protocol whereby routes to and from said mobile router for both said signalling channel and said data channel are substantially route optimized.

3. A method according to claim 1, further comprising the step of utilising a plurality of multicast groups on behalf of said plurality of mobile network nodes.

4. A method according to claim 3, wherein use of the or each multicast group enables a respective function to be performed for said plurality of mobile network nodes whilst attached to said mobile router.

5. A method according to claim 1, wherein each mobile network node is associated with a remote network node that provides a session management function therefor, the method further comprising the step of causing all of the remote network nodes to join a first multicast group, whereby changes in a network layer address of said mobile router may be notified to all of said remote network nodes with a single multicast message.

6. A method according to claim 5, wherein the step of causing said remote network nodes to join said first multicast group comprises.
(a) receiving from a mobile network node a registration message intended to update said associated remote network node;
(b) adding to said registration message a multicast address field comprising the first multicast address of said first multicast group; and
(c) forwarding said registration message toward said associated remote network node;
whereby said remote network node is caused to join said first multicast group.

7. A method according to claim 1, wherein when said mobile router changes network subnet the method further comprises the steps of:
(a) generating a group register message comprising the new care-of network layer address of said mobile router and a list of those mobile network nodes presently attached thereto; and
(b) causing said group register message to be sent to said first multicast group using said first multicast address.

8. A method according to claim 1, further comprising the step of forming a second multicast group comprising one or more remote network node associated with the or each mobile network node for which a session has been established.

9. A method according to claim 8, wherein forming said second multicast group comprises the step of causing said one or more remote network node to be invited to join said second multicast group during establishment of said session, whereby the number of members of said second multicast group is dynamic.

10. A method according to claim 8, wherein said one or more remote network node comprises a correspondent node with which said mobile network node has an ongoing session.

11. A method according to claim 8, wherein said one or more remote network node provides a session management function for said mobile network node with an ongoing session.

12. A method according to claim 8, further comprising the steps of:
(a) detecting a change in the network layer address of said mobile router; and
(b) causing the new network layer address of said mobile router to be sent to the multicast address of said second multicast group, whereby only those remote network nodes associated with the or each mobile network node with an ongoing session are updated with said new network layer address.

13. A method according to claim 12, further comprising the step of sending a group invitation message to said second multicast group, which group invitation message comprises an identity of each correspondent node that has an ongoing session with at least one of said mobile network nodes.

14. A method according to claim 13, whereby upon receipt of said group invitation message, said correspondent node searches said group invitation message for its identity and, if found, addresses datagrams in said data channel to said new network layer address.

15. A method according to claim 1, wherein provision of said signalling channel comprises the step of sending messages in accordance to the Session Initiation Protocol (SIP).

16. A method according to claim 15, wherein said multicast function is provided by a SIP server (MR-SS) remote from said mobile router, said multicast function being triggered by messages sent from said mobile router.

17. A computer program comprising computer executable instructions for causing a mobile router to perform the method steps of claim 1.

18. A computer program product storing computer executable instructions in accordance with claim 17.

19. A computer program product as claimed in claim 18, embodied on a record medium, in a computer memory, in a read-only memory or on an electrical carrier signal.

20. For use in a method according to claim 1, a mobile router comprising an electronic memory storing computer executable instructions that when executed enable the mobile router to perform the steps of claim 1.

21. A mobile network comprising a mobile router as claimed in claim 20.

22. For use in a method according to claim 1, a datagram comprising a signaling message in its payload, which signaling message comprises a SIP-like message structure having a header field comprising a multicast address, said datagram useable to cause remote network nodes to join a multicast group represented by said multicast address.

23. A data communication network adapted to perform the network method steps of claim 1.

24. A method of updating a SIP User Agent (UA) on a mobile network node, which method comprises the steps of:
transmitting an update to said mobile network node; and
causing said mobile network node to install said update; which update comprises;
computer executable instructions for causing said mobile network node to join a multicast group in response to receipt of a SIP-like signalling message.

25. A mobile network node comprising a memory storing computer executable instructions for causing said mobile network node to join a multicast group in response to receipt of a SIP-like signalling message.

26. A network node (MR-SS) for managing a plurality of mobile network nodes attached to a mobile router, which network node comprises a memory storing computer executable instructions that when executed cause said network node to provide a signalling channel for said mobile network nodes by utilising a multicast communication protocol.

27. A network node as claimed in claim 24, wherein said network node comprises a SIP server.
